(19) United States
(12) Patent Application Publication
(10) Pub. No.: US 2023/0102147 A1
(43) Pub. Date: Mar. 30, 2023

(54) Harrison's Portable Emergency Light

(71) Applicant: Gerald Dewayne Harrison, Houston, TX (US)

(72) Inventor: Gerald Dewayne Harrison, Houston, TX (US)

(21) Appl. No.: 16/795,035

(22) Filed: Feb. 19, 2020

(51) Int. Cl. F21L 4/04; F21L 4/08; F21L 4/02

(52) U.S. Cl. CPC F21L 4/04; F21L 4/08; F21L 4/02

(57) ABSTRACT

1. The Harrison's portable emergency light is made of plastic.

2. It is also made of plexiglass.

3. It is also made of aluminum.

### BACKGROUND OF INVENTION

The Harrison Portable Emergency Light is used in emergency situations. It will be used to block traffic. The emergency light will close off streets, highway entrances, and exits. The portable light will be used to block of areas such as crime scenes and areas that need to be closed to the general public.

The idea for the light came to me as I was working an accident on the highway in Dallas, Tex. as a police officer in training with the Dallas Police Department. I was putting the flares around the accident and I almost got hit by a civilian in a Lincoln town car. Yes, it was a scary situation.

### BRIEF DESCRIPTION OF THE DRAWINGS

FIG. 1 discloses the entire device.

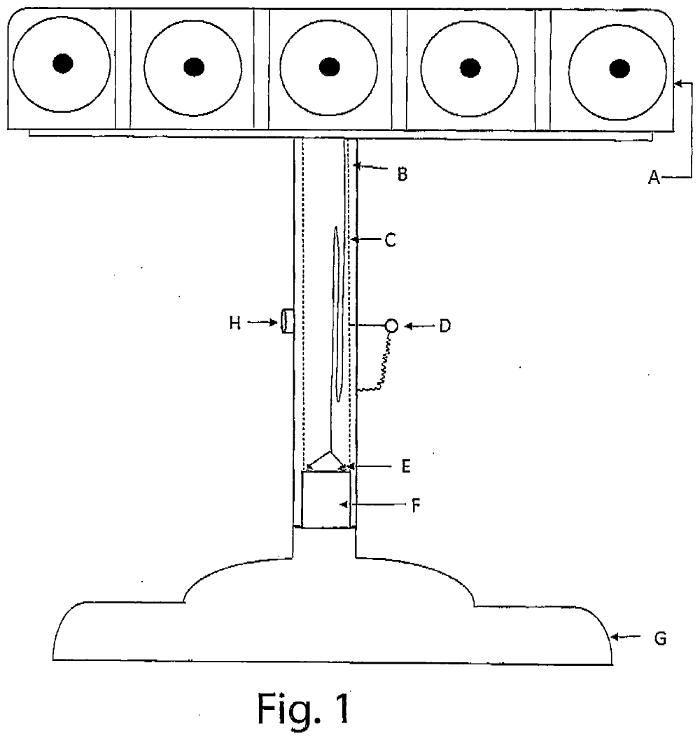

FIG. 2 discloses the light.

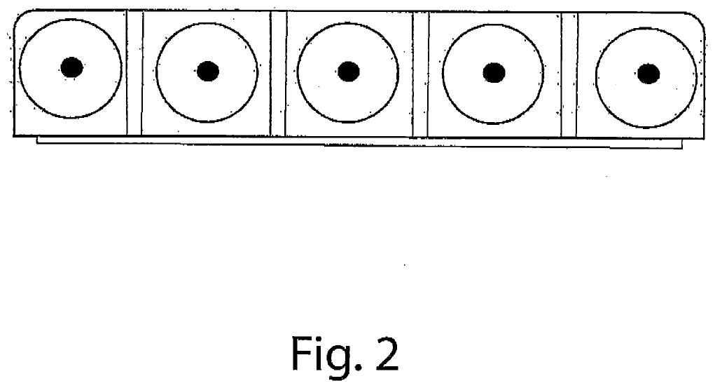

FIG. 3 disclose the body. Request for Customer Number

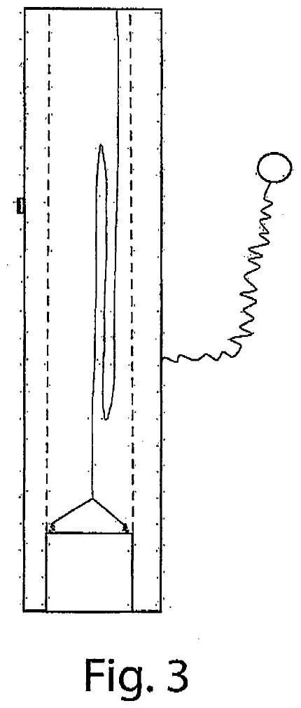

FIG. 4 discloses the base.

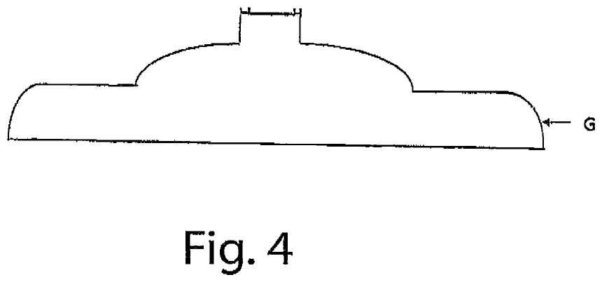

The drawings include the following labeled elements:
A. Emergency Light
B. Extended Column
C. Casing for Electrical Wire
D. Latch Pin to hold Extended Column in place
E. In Line Switch Battery
F. Battery
G. Base
H. Height Adjusted Pin

### DETAILED DESCRIPTION OF THE INVENTION

The Harrison Portable Light consists of three parts. 1. The top includes an emergency light which is a strobe light just like a policy car (on top) for law enforcement. The light can be other colors for non-law enforcement agencies. 2. A pcp pipe is the second part which may be cylindrical, and may include a sleeved stand, a height adjustable pin and slot, and may house the batteries, an inline switch and wires. The pipe can be made of any material depending on what the client's wants. The length and circumference can be determined by the client as well. 3. The base can be a flat surface or a three pronged stand and may include fasteners for attaching to the pcp pipe.

This emergency light can be used to block off an area or guide people to a safe area. It can also be used as a warning light or a beacon.

1. The claim pertains to the body of the invention. The inner working of the body contains the important part of the invention. It is structed so the power is given to the emergency to work by wiring and rechargeable battery.
